(19) United States
(12) Patent Application Publication
(10) Pub. No.: US 2024/0058745 A1
(43) Pub. Date: Feb. 22, 2024

(54) METHOD AND SYSTEM FOR ABSORBING A COMPONENT OF A GAS STREAM INTO A LIQUID

(71) Applicant: GTI ENERGY, Des Plaines, IL (US)

(72) Inventor: Osman Akpolat, Northbrook, IL (US)

(73) Assignee: GTI ENERGY, Des Plaines, IL (US)

(21) Appl. No.: 18/233,548

(22) Filed: Aug. 14, 2023

Related U.S. Application Data
(60) Provisional application No. 63/398,275, filed on Aug. 16, 2022.

(51) Int. Cl. B01D 53/14; B01D 53/18

(52) U.S. Cl. CPC B01D 53/1425; B01D 53/18; B01D 2258/0283

(57) ABSTRACT

A system and method for removing a component from a gas stream. The method includes absorbing the component from a gas stream in a solvent, separating the component from the solvent, and recycling the solvent back to the absorbing step. The absorbing is desirably performed by a counter-current contact between the solvent and the gas stream, such as using a rotating packed bed absorber. The rotating packed bed absorber is paired with a multistage solvent regeneration system configured to receive a rich solution from the rotating packed bed absorber and return a recycled lean solution to the rotating packed bed absorber.

### CROSS-REFERENCE TO RELATED APPLICATIONS

This application claims the benefit of U.S. Provisional Application, Ser. No. 63/398,275, filed on 16 Aug. 2022. The co-pending provisional application is hereby incorporated by reference herein in its entirety and is made a part hereof, including but not limited to those portions which specifically appear hereinafter.

### GOVERNMENT SUPPORT CLAUSE

This invention was made with government support under award number DE-FE0031630 awarded by the Department of Energy. The government has certain rights in the invention.

### FIELD OF THE INVENTION

This invention relates generally to removing components from gas streams, and more particularly to a method and system for absorbing gas stream components (e.g., carbon) into a liquid solvent.

### BACKGROUND OF THE INVENTION

There is a continuing need for improved gas stream cleaning systems, such as with reduced cost and size of the separation equipment, and/or that reduces the energy needed to produce carbon dioxide at a liquid phase.

### SUMMARY OF THE INVENTION

A general object of the invention is to provide a method and system for preferentially absorbing a component (e.g., CO₂) of a gas stream into a liquid solvent, to separate the component from the gas stream. The process produces, for example, clean flue gas and a liquified carbon component (CO₂) product.

The general object of the invention can be attained, at least in part, through a method of removing a component from a gas stream, such as a flue gas. The method includes absorbing the component in a solvent, separating the component from the solvent, and recycling the solvent back to the absorbing step. In embodiments of this invention, the absorbing is performed by a counter-current contact between the solvent and the gas stream, such as using a single or multi-stage rotating packed bed absorber. The solvent desirably flows from a center of a rotating packed bed radially outward through a packed absorber bed, and the gas stream flows inward through the packed absorber bed.

In embodiments of this invention, the separating is performed by a two-stage solvent regeneration. A first stage removes a first portion of the absorbed carbon, and the second stage removes a second portion of the absorbed carbon. Further stages can be added, depending on need.

Absorbing the compound in the solvent results in a loaded solvent, and the separating preferably includes pressurizing and heating the loaded solvent, followed by flash distillation of the loaded solvent. The flash distillation comprises a first distillation at a first temperature and pressure followed by a second distillation at a second temperature and pressure that is lower than the first temperature and pressure.

The invention further includes a system for removing a component from a gas stream. The system includes an absorber, such as a rotating packed bed, for component absorption, and a multi-stage (e.g., two-stage) solvent regeneration system connected to the absorber. The regeneration system is configured to receive a rich solution from the rotating packed bed and return a recycled lean solution to the absorber.

In embodiments, the system includes a solvent inlet in combination with a center of a rotating packed bed, and a gas stream inlet in combination with an outer surface of the rotating packed bed. The rotating packed bed is configured to move the solvent through a packing material in a counter current manner to the gas stream.

In embodiments, the multi- or two-stage solvent regeneration system includes a flash distillation apparatus. The flash distillation apparatus desirably includes a first distillation device configured to operate at a first temperature and pressure followed by a second distillation device configured to operate at a second temperature and pressure that is lower than the first temperature and pressure.

The system further includes one or more pumps and at least one of: a heat exchanger and a heater, disposed between the rotating packed bed and the solvent regeneration system, to increase or decrease the temperature of the solvent throughout the system, depending on the position within and the component requirements of the system. In some embodiments, a heat transfer occurs between the rich solvent and the lean/recycled solvent, such as using a heat exchanger configured to transfer heat from the recycled lean solution to the rich solution.

Other objects and advantages will be apparent to those skilled in the art from the following detailed description taken in conjunction with the appended claims and drawings.

### BRIEF DESCRIPTION OF THE DRAWINGS

FIG. 1 is a general schematic layout of a system according to one embodiment of this invention.

FIG. 2 is a general schematic layout of a system according to one embodiment of this invention.

FIG. 3 is a sectional view of a rotating packed bed absorber according to one embodiment of this invention.

### DESCRIPTION OF THE INVENTION

The invention provides a method and system for preferentially absorbing a component (e.g., CO₂) of a gas stream, such as flue gas, into a liquid solvent, separated from the gas stream. The process produces, for example, clean flue gas and a liquified carbon component (CO₂) product.

In embodiments of this invention, a single or multi-stage packed bed absorber contacts a gas with a solvent to absorb one or more gas components to the liquid. The liquid is pressurized and circulated to an energy efficient solvent regeneration process, such as described in U.S. Pat. No. 9,901,846, herein incorporated by reference, where the solvent is regenerated. The resulting solvent is circulated back to the rotating packed bed for further use and absorption. The invention can be incorporated with one or more rotating packed bed absorbers.

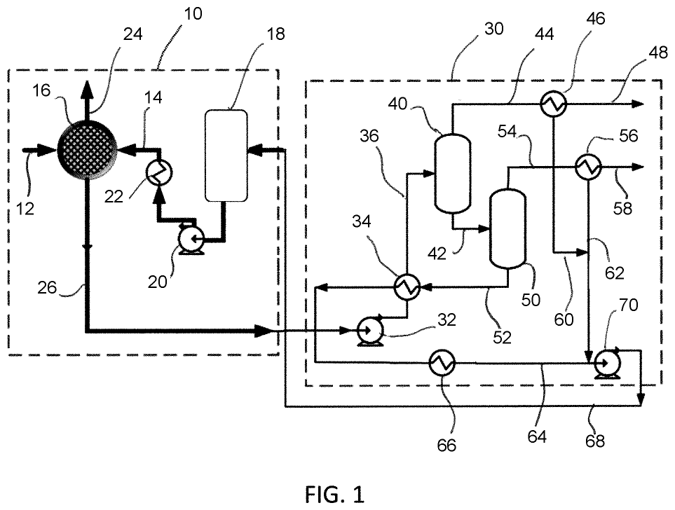

FIG. 1 shows an exemplary schematic of the system and method according to one embodiment of the invention. FIG. 1 includes a packed bed absorption subsystem 10 and a multi-stage desorption subsystem 30. A feed gas 12 and a lean absorption solvent 14 are fed to a packed bed absorber 16, which is preferably a rotating packed bed absorber. A supply of the lean solvent 14 can be intermediately stored in a storage tank 18, and transferred to the absorber 16 by pump 20, optionally adjusted in temperature by heat exchanger 22. The absorber 16 outputs a cleaned gas stream 24, and, for example, a rich CO₂ solution stream 26.

Stream 26 is introduced to desorption system 30. The desorption system 30 is desirably a multi-stage regeneration system, with the number of stages being variable depending on need, and with each step reducing the absorbed components from the solvent by an additonal amount. The desorption system 30 is illustrated as a two-stage solvent regeneration process for removing carbon dioxide from the carbon dioxide-loaded solvent 26. The carbon dioxide-loaded solvent stream 26 is pressurized using a pump 32, heated using a heat exchanger 34, and is then fed as heated stream 36 to a first stage flash apparatus 40. The first pressure is suitably at least about four atmospheres, more desirably at least about eight atmospheres, and preferably at least about ten atmospheres. The first temperature is suitably at least about 125° C., more desirably at least about 135° C., and preferably at least about 145° C. The first stage flash apparatus 40 can be any suitable flash distillation device, such as a once-through reboiler or another suitable flash apparatus with heating elements.

The carbon dioxide-loaded solvent stream 36 can have a first carbon dioxide content (prior to any carbon dioxide removal) in a range of about 1-12% by weight, suitably at least about 8% by weight, and can be higher or lower depending on the specific solvent and the specific application. Suitable solvents include without limitation aqueous ammonia, amine-based solvents such as monoethanolamines, diethanolamines and triethanolamines, aqueous potassium carbonate, and other known solvents. One suitable solvent is activated N-methyl diethanolamine (“aMDEA”), which contains piperazine activating agent.

Carbon dioxide is flashed from the carbon dioxide-loaded solvent in the first stage flash apparatus 40 to yield a first treated solvent 42 having a second carbon dioxide content that is lower than the first carbon dioxide content of stream 36, and a first carbon dioxide-containing gas stream 44. The first carbon dioxide-containing gas stream 44 exits the first stage flash apparatus 40 and is fed to a heat exchanger and/or condenser 46 that condenses any solvent or water vapor and separates the vapor from the carbon dioxide gas 48. The first treated solvent stream 42 exits the first stage flash apparatus 40 and is fed to the second stage flash apparatus 50 at a second temperature that is lower than the first temperature and a second pressure that is lower than the first pressure.

The first treated solvent 42 has a second carbon dioxide content that is lower than the first carbon dioxide content of stream 36 and is suitably at least about 30% lower, or at least about 50% lower, and preferably at least about 75% lower than the first carbon dioxide content. By way of example, when the first carbon dioxide content is about 8-12% by weight, the second carbon dioxide content can be about 6% or less by weight, more desirably about 4% or less by weight, and preferably about 2% or less by weight. The second temperature is suitably at least about 5° C. less than the first temperature, more desirably at least about 15° C. less than the first temperature, and preferably at least about 25° C. less than the first temperature, and is suitably not more than about 130° C., more desirably not more than about 120° C., and preferably not more than about 110° C. The second pressure is suitably at least about 50% less than the first pressure, more desirably at least about 60% less than the first pressure, and preferably at least about 75% less than the first pressure, with all pressures described herein measured on an absolute basis. For example, when the first pressure is about 6-10 atmospheres, the second pressure is suitably not more than about three atmospheres, or not more than about 1.5 atmospheres.

Carbon dioxide is flashed from the first treated solvent 42 in the second stage flash apparatus 50 to yield a second treated solvent 52 having a third carbon dioxide content that is lower than the second carbon dioxide content, and a second carbon dioxide-containing gas stream 54. The second carbon dioxide-containing gas stream 54 exits the second stage flash apparatus 50 and is fed to a heat exchanger and/or condenser 56 that condenses any vapor and separates it from the carbon dioxide gas 58.

The condensed solvent streams 60 and 62 exit the condensers 46 and 56, and are added to a second treated solvent steam 64 after the stream 52 exits the second stage flash apparatus 50 and passes through the cross-exchanger 34 and a cooler 66. The second treated solvent stream 64, with the condensed streams 60 and 62 added thereto, becomes stream 68 and can then be transferred using solvent pump 70 to tank 18 for reuse in the carbon dioxide absorption process 10.

The second stage flash apparatus 50 can be a standard flash tank or another suitable flash apparatus, the same as of different from apparatus 40. The second treated solvent 52 has a third carbon dioxide content that is lower than the second carbon dioxide content and is suitably at least about 30% lower, more desirably at least about 50% lower, and preferably at least about 90% lower than the second carbon dioxide content. For example, when the second carbon dioxide content is about 2-6% by weight, the third carbon dioxide content can be not more than about 4.0% by weight, more desirably not more than about 1% by weight, and preferably not more than about 0.2% by weight.

Alternatively, but not required, the second treated solvent stream 52 can be fed to a one or more further flash apparatus stages whose structure and operation mimics that of the first and/or second stage flash apparatus.

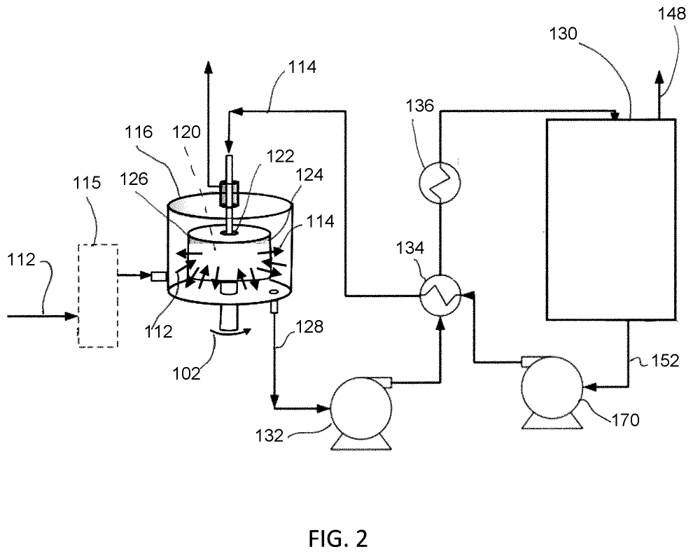

FIG. 2 shows a system 100 with additional details of a rotating (see rotation arrow 102) packed bed absorber according to one embodiment of the invention. The rotating packed bed absorber 116 is embodied as a high gravity reactor, with a rotating disk 118 of a packing material 120 that generates a high gravity centrifugal force. Flue gas 112 flows, optionally through cooler and/or filter 115 into absorber 116. Solvent 114 flows from the inner radius/edge 122 of the rotating disk radially towards the outer radius/edge 124 under centrifugal force generated by the rotation of the packed bed 126. Incoming countercurrent flue gas 112, moving from the outer radius 124 to the inner radius 122, contacts the solvent 114.

Rich solvent 128 moves by pump 132 through heat exchanger 134 and additional heater 136 to regeneration system 130. The regeneration system 130 is again desirably a multi-stage system, and can be as described in FIG. 1, or can be one or more further rotating packed bed reactors, similar to reactor 116, except the rich solvent moves radially outward and the inlet gas is steam or other scrubbing medium. CO₂ stream 148 is released and captured, and lean solvent 152 moves by pump 170 through heat exchanger 134 and back to the rotating bed 116. The invention thus provides a continuous process having a relatively small footprint as compared to previous systems.

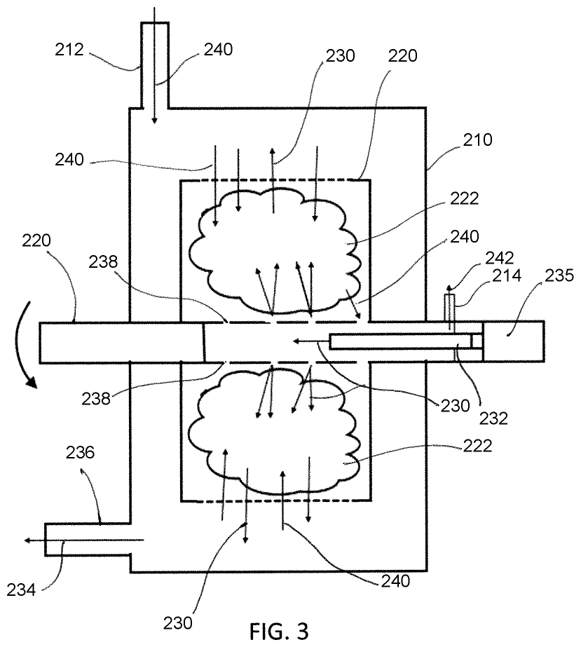

FIG. 3 shows a rotating packed bed absorber 200 according to one embodiment of the invention. The absorber 200 is shown with a horizontal axis of rotation, but can be oriented in any position depending on need. An outer chamber 210 encloses a packed bed 220, enclosing a packed bed material 222, which rotates about rotation shaft 220. Lean solvent 230 enters through solvent line 232, and due to rotation forces is expelled radially through the packed bed 220 and material 222. A gas stream 240 enters though inlet 212, and moves countercurrent to the solvent 230. The clean gas stream 242 exits gas outlet 214. Rich (e.g., CO₂ saturated) solvent 234 collects in the chamber 210 and exits through rich solvent line 236. The rotating bed 220 includes openings to allow the solvent and gas to both enter and exit in the countercurrent manner.

In embodiments, the solvent inlet 232 can incorporate a rotating liquid coupler 235, which can be incorporated into the hollow rotation shaft 220. The rotating liquid coupler 235 includes a bearing and a seal, and has one section connected to the shaft 220 and which rotates, and another section connected to the piping from a lean solvent pump and is stationary. The shaft 220 is hollow and allows the liquid injectors to rotate with the shaft 220 and packing 220. This way the liquid injection points 238 (injectors) stay stationary with respect to the packing (similar to a conventional column) and the solvent is not injected from a stationary injector to a rotating packing. A resulting benefit is a more uniform distribution of the liquid on the surface area of the packing, particularly at the inner radius cross sectional area where the liquid first hits the packing similar to the top of a conventional column.

Various sizes, shapes, and configurations are available for the rotating absorber and regeneration systems of this invention. As an example, multiple stages of rotating beds can be used, such as including two, three, or more rotating packed bed absorbers. These can be arranged as separate units or stacked one after the other using a common shaft to simultaneously rotate all.

The invention provides a more compact, less-expensive system, which can use solvents that cannot be used with conventional equipment. The inventive method and system uses less energy to separate the gas stream, is not effected by motion as much as a tall conventional column, produces high pressure CO₂, and reduces gas compression energy needed for separated gas product.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method of removing a component from a gas stream, the method comprising:
absorbing the component in a solvent;
separating the component from the solvent; and
recycling the solvent back to the absorbing step.

2. The method of claim 1, wherein the absorbing is performed by a counter-current contact between the solvent and the gas stream.

3. The method of claim 1, wherein the absorbing is performed in a rotating packed bed absorber.

4. The method of claim 3, wherein the solvent flows from a center of a rotating packed bed radially outward through a packed absorber bed, and the gas stream flows inward through the packed absorber bed.

5. The method of claim 3, wherein the solvent flows into the rotating packed bed absorber through a hollow rotating shaft of the rotating packed bed absorber.

6. The method of claim 1, wherein the separating is performed by a two stage solvent regeneration.

7. The method of claim 6, wherein a first stage removes a first portion of the absorbed carbon, and the second stage removes a second portion of the absorbed carbon.

8. The method of claim 1, wherein the absorbing the compound in the solvent results in a loaded solvent, and the separating comprises:
pressurizing and heating the loaded solvent; and
flash distillation of the loaded solvent.

9. The method of claim 1, wherein the flash distillation comprises a first distillation at a first temperature and pressure followed by a second distillation at a second temperature and pressure that is lower than the first temperature and pressure.

10. The method of claim 1, wherein the gas stream is a flue gas stream.

11. A system for removing a component from a gas stream, comprising:
a rotating packed bed for component absorption; and
a two-stage solvent regeneration system connected to the rotating packed bed and configured to receive a rich solution from the rotating packed bed and return a recycled lean solution to the rotating packed bed.

12. The system of claim 11, further comprising a solvent inlet in combination with a center of the rotating packed bed, and a gas stream inlet in combination with an outer surface of the rotating packed bed, wherein the rotating packed bed is configured to move a solvent through a packing material in a counter current manner to the gas stream.

13. The system of claim 11, wherein the two-stage solvent regeneration system comprises a flash distillation apparatus.

14. The system of claim 13, wherein the flash distillation apparatus comprises a first distillation device configured to operate at a first temperature and pressure followed by a second distillation device configured to operate at a second temperature and pressure that is lower than the first temperature and pressure.

15. The system of claim 11, further comprising a pump and at least one of: a heat exchanger and a heater, disposed between the rotating packed bed and the two-stage solvent regeneration system.

16. The system of claim 11, further comprising a heat exchanger configured to transfer heat from the recycled lean solution to the rich solution.
